(19) United States
(12) Patent Application Publication
(10) Pub. No.: US 2017/0355853 A1
(43) Pub. Date: Dec. 14, 2017

(54) METHOD FOR MANUFACTURING LIQUID CRYSTAL DISPLAY DEVICE

(71) Applicant: Sharp Kabushiki Kaisha, Sakai City, Osaka (JP)

(72) Inventors: Hiroaki ASAGI, Sakai City (JP); Isamu MIYAKE, Sakai City (JP); Yuichi KAWAHIRA, Sakai City (JP)

(21) Appl. No.: 15/531,380

(22) PCT Filed: Nov. 26, 2015
(86) PCT No.: PCT/JP2015/083236

§ 371 Date: May 26, 2017

(30) Foreign Application Priority Data
Nov. 28, 2014 (JP) 2014-242115
Jun. 8, 2015 (JP) 2015-115806

(51) Int. Cl. C08L 101/02; C08L 101/04; C08L 101/10; G02F 1/1337

(52) U.S. Cl. CPC C08L 101/025; G02F 1/1337; G02F 1/133723; C08L 101/04; C08L 101/10; G02F 2202/025

(57) ABSTRACT

The present invention provides a method for manufacturing a liquid crystal display device which requires a reduced light irradiation dose in the alignment treatment for a photo-alignment film and achieves a favorable contrast ratio and a viewing angle property. The method for manufacturing a liquid crystal display device includes, in the following order, the steps of: (1) forming on a substrate a film of a photo-alignment film material containing two or more polymers and a solvent; (2) pre-baking the film to evaporate the solvent; (3) post-baking the pre-baked film gradually at multiple temperatures from a low temperature to a high temperature; and (4) irradiating the post-baked film with polarized light, at least one of the two or more polymers being a photo-reactive polymer containing a photo-functional group in a side chain.

### TECHNICAL FIELD

The present invention relates to methods for manufacturing a liquid crystal display device. Specifically, the present invention relates to a method for manufacturing a liquid crystal display device which relates to the formation conditions of an alignment film.

### BACKGROUND ART

Thin-profile display devices such as liquid crystal display devices have rapidly spread in recent years, and are widely used for not only televisions but also devices such as electronic books, digital photo frames, industrial appliance (IA), personal computers (PCs), tablet PCs, and smartphones.

Liquid crystal display devices require uniform alignment of liquid crystal molecules. The alignment of liquid crystal molecules is achieved by alignment treatment for alignment films, such as rubbing or photo-alignment, and rubbing in which the surface of an alignment film is rubbed with a cloth has widely been used. The rubbing, however, causes problems such as foreign-matter defects due to dust of cloth and display unevenness, and breaking of thin-film transistors due to static electricity generated in rubbing with a cloth. In addition, as the definition of devices such as tablet PCs and smartphones increases, it has become difficult to uniformly align the liquid crystal molecules by rubbing of which the alignment precision is restricted by the density of the cloth fiber. In order to solve these problems of the rubbing, photo-alignment has been recently developed which irradiates an alignment film with light such as UV light to give anisotropy to the film such that the film has the alignment force.

The photo-alignment for forming an alignment film typically includes the steps of applying an alignment film material, pre-baking, post-baking, and polarized-light irradiation in the given order. Various studies have also been made on the alignment film material. For example, Patent Literature 1 discloses a photo-alignment film composition containing a photo-reactive compound with a high degree of freedom in material selection.

Recent developments to increase the orientational order of polymers include post-baking during the course of alignment film formation. For example, Non-Patent Literature 1 discloses post-baking after application of polyamic acid containing azobenzene in the main chain to a substrate and irradiation of the substrate with linearly polarized UV light. This report states that the orientational order of the obtained polyimide alignment film measured after the post-baking was higher than the orientational order measured before the post-baking. Patent Literature 2 also states that highly efficient introduction of anisotropy to a side-chain polymer film on a substrate is achieved by irradiating the film with polarized UV light and heating the film.

### CITATION LIST

### Patent Literature

Patent Literature 1: WO 2012/093682
Patent Literature 2: WO 2013/081066

### Non-Patent Literature

Non-Patent Literature 1: K. Sakamoto, et al., “In-plane Molecular Order of a Photo-oriented Polyamic Acid Film: Enhancement upon Thermal Imidization”, Molecular Crystals and Liquid Crystals, the U.S., Taylor & Francis Inc., 2004, Vol. 412, pp. 293-299

### SUMMARY OF INVENTION

### Technical Problem

The photo-alignment, however, has problems that it is not likely to achieve sufficient alignment force and requires large energy (irradiation dose) in light irradiation (e.g., polarized-light irradiation) in order to achieve a higher contrast ratio than that of a product to which the alignment treatment was performed by rubbing. For example, the photo-alignment requires an irradiation dose of polarized light of more than several hundreds of millijoules per square centimeter, or even several joules per square centimeter in some cases. A large irradiation dose of polarized light for alignment treatment results in problems such as accelerated deterioration of the exposure device and damage on the organic films constituting the substrates of the liquid crystal display device, as well as prolonged treatment time. The photo-alignment also has a problem of an insufficient viewing angle.

The invention disclosed in Patent Literature 1 does not show the details of the process of baking an alignment film, and can still be improved in terms of optimization of the post-baking conditions and a further increase in the polymer orientational order in order to solve the above problems.

Non-Patent Literature 1 merely discloses post-baking conditions of 250° C. and one hour, and can still be improved in terms of optimization of the post-baking conditions in order to solve the above problems. Also, Non-Patent Literature 1 fails to disclose a process related to pre-baking. Without pre-baking, the resulting photo-alignment film unfortunately has thickness unevenness and exhibits a deteriorated display quality.

The invention disclosed in Patent Literature 2 provides an insufficient viewing angle, and can still be improved in terms of optimization of the process of baking an alignment film in order to solve the above problems.

The present invention was made in view of such a current state of the art, and aims to provide a method for manufacturing a liquid crystal display device which requires a reduced light irradiation dose in alignment treatment for a photo-alignment film and achieves a favorable contrast ratio and a favorable viewing angle property.

### Solution to Problem

The inventors made studies on the method for reducing the light irradiation dose in the photo-alignment, and first focused on a method which performs post-baking after light irradiation as disclosed in Non-Patent Literature 1 and Patent Literature 2. This method can increase the orientational order of the polymer constituting the photo-alignment film by post-baking, i.e., can achieve what is called self-organization, thereby achieving sufficient alignment force even with a reduced light irradiation dose. The inventors, however, found that a self-organized photo-alignment film unfortunately produces large retardation to narrow the viewing angle of the liquid crystal display device.

The inventors therefore made studies on the factors increasing the required irradiation dose of polarized light in the photo-alignment, and then focused on use of an alignment film material containing a mixture of two or more polymers such as a photo-reactive polymer and a non-photo-reactive polymer. As a result, the inventors found that with insufficient layer separation of the photo-reactive polymer and the non-photo-reactive polymer in the alignment film, the orientational order is less likely to increase, and thus a large irradiation dose of polarized light is required in the polarized-light irradiation step after the post-baking step.

Based on these findings, the inventors conceived of gradual post-baking at multiple temperatures from a low temperature to a high temperature. The inventors found that such gradual post-baking at multiple temperatures from a low temperature to a high temperature, not at a single temperature, promotes layer separation of the photo-reactive polymer and the non-photo-reactive polymer, and results in a larger amount of the photo-reactive polymer in the upper portion of the alignment film and a larger amount of the non-photo-reactive polymer in the lower portion of the alignment film. Also, the gradual post-baking at multiple temperatures from a low temperature to a high temperature was found to enable sufficient removal of the solvent contained in the alignment film material. Under this condition, polarized-light irradiation performed after the post-baking does not involve self-organization of the polymer constituting the alignment film, and can thus achieve small retardation of the alignment film. Such a method was found to be able to achieve a favorable viewing angle property.

The inventors also focused on the structure of the photo-reactive polymer. As a result, the inventors found that, in the case of a photo-reactive polymer containing photo-functional groups in side chains, even a small irradiation dose of polarized light after post-baking can re-align the side chains to give uniaxial anisotropy to the alignment film. Also in this case, the retardation of the alignment film was found to be kept very small.

Thereby, the inventors arrived at a solution to the above problems, completing the present invention.

One aspect of the present invention may be a method for manufacturing a liquid crystal display device including a photo-alignment film, the method including, in the following order, the steps of: (1) forming on a substrate a film of a photo-alignment film material containing two or more polymers and a solvent; (2) pre-baking the film to evaporate the solvent; (3) post-baking the pre-baked film gradually at multiple temperatures from a low temperature to a high temperature; and (4) irradiating the post-baked film with polarized light, at least one of the two or more polymers being a photo-reactive polymer containing a photo-functional group in a side chain.

### Advantageous Effects of Invention

One aspect of the present invention can provide a method for manufacturing a liquid crystal display device which requires a reduced light irradiation dose in the alignment treatment for a photo-alignment film and achieves a favorable contrast ratio and a viewing angle property.

### DESCRIPTION OF EMBODIMENTS

A method for manufacturing a liquid crystal display device according to the present embodiment is a method for manufacturing a liquid crystal display device including a photo-alignment film, and includes, in the following order, the steps of: (1) forming on a substrate a film of a photo-alignment film material containing two or more polymers and a solvent; (2) pre-baking the film to evaporate the solvent; (3) post-baking the pre-baked film gradually at multiple temperatures from a low temperature to a high temperature; and (4) irradiating the post-baked film with polarized light, at least one of the two or more polymers being a photo-reactive polymer containing a photo-functional group in a side chain.

The step (1) can be performed by an application method by ink jetting or spin coating, or a printing (transferring) method by flexography. Any of these methods may be used to form the above film from the above photo-alignment film material such that the film can be functionalized to serve as a photo-alignment film through the subsequent steps. The conditions for forming the above film may appropriately be set to suit the method for forming the above film and other conditions. The thickness and other dimensions of the above film may be the same as those of a typical photo-alignment film. The substrate on which the above film is formed may be any substrate on which treatment for forming a photo-alignment film is to be performed, and may be a substrate on which various treatments have been performed.

The photo-alignment film material used in the above step (1) contains two or more polymers and a solvent, and constitutes a photo-alignment film after the above steps (1) to (4). In other words, the above photo-alignment film is a film that has obtained the alignment force for the liquid crystal molecules through a chemical reaction of the photo-functional group in the polymer under irradiation of light.

At least one of the two or more polymers is a photo-reactive polymer containing a photo-functional group in a side chain. A photo-reactive polymer containing a photo-functional group in a side chain can re-align the side chains to give uniaxial anisotropy to the alignment film even through a polarized-light irradiation step after the post-baking step. The photo-reactive polymer preferably has sufficient characteristics for an alignment film after appropriate post-baking. Here, a photo-reactive polymer containing a photo-functional group in the main chain causes the alignment film to be a highly dense polymer film through the post-baking step. Hence, it is difficult to re-align the polymer main chains to give uniaxial anisotropy to the alignment film even under polarized-light irradiation, bringing the need for a very large irradiation dose of polarized light in the alignment treatment.

The photo-functional group may be at least one functional group selected from the group consisting of cinnamate, chalcone, coumarin, stilbene, phenolic ester, and azobenzene groups. In particular, a cinnamate group is preferred.

The photo-reactive polymer may have at least one structure selected from the group consisting of polysiloxane, polyamic acid, polyimide, and maleimide.

Examples of the photo-reactive polymer include compounds having a structure represented by the following formula (1).

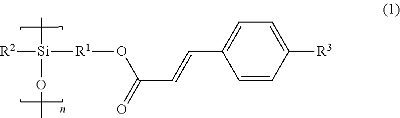

In the formula, R¹ represents a single bond or a divalent organic group; R² represents a monovalent organic group: R³ represents —H, —F, or a monovalent organic group; and n represents an integer of 2 or greater.

The divalent organic group preferably contains at least one selected from the group consisting of alkylene, ether, and ester groups, for example. The monovalent organic group preferably contains at least one selected from the group consisting of alkyl, phenyl, carbonyl, epoxy, ether, and ester groups, for example.

The proportion of the photo-reactive polymer in the total solids content of the photo-alignment film material may be 5 to 30 wt %. Even with a proportion of the photo-reactive polymer in the above range, the photo-reactive polymer can be sufficiently exposed on the liquid crystal layer side of the alignment film through the above steps (1) to (4). Also, reduction of the photo-reactive polymer content enables an increase in the proportion of the non-photo-reactive polymer which has an effect on improvement of the electric characteristics, further increasing the VHR. Also, in the case that the above photo-reactive polymer is a colored polymer that can absorb light having a wavelength in the visible light range, for example, decreasing the proportion in the total solids content enables an increase in the light transmittance of the photo-alignment film, leading to an increase in the light transmittance of the liquid crystal display panel.

The two or more polymers may include a non-photo-reactive polymer containing at least one of polyamic acid and polyimide as a main chain. The proportion of the non-photo-reactive polymer may be 70 to 95 wt % in the total solids content of the photo-alignment film material. Since the non-photo-reactive polymer has an effect on improvement of the electric characteristics, setting the proportion of the non-photo-reactive polymer in the above range enables achievement of a higher VHR.

In particular, setting the proportion of the photo-reactive polymer to 5 to 30 wt % and the proportion of the non-photo-reactive polymer to 70 to 95 wt % in the total solids content of the photo-alignment film material enables achievement of both a favorable contrast ratio and a higher VHR.

The solvent may be any liquid (at room temperature) that can dissolve or disperse therein the two or more polymers. The solvent is removed from the photo-alignment film material in the above steps (2) and (3). The solvent may contain not only a component (good solvent) suited for dissolving the polymer but also a component (poor solvent) suited for spreading the photo-alignment film material with a uniform thickness on the substrate, and is preferably a mixture of these components. The solvent may be a mixture of at least one compound selected from the group consisting of N-methyl-2-pyrrolidone, N-ethyl-pyrrolidone, and γ-butyrolactone and at least one compound selected from the group consisting of butyl cellosolve, diethylene glycol diethyl ether, diisobutyl ketone and structural isomers thereof, ethylene glycol monobutyl ether, propylene glycol monobutyl ether, and diacetone alcohol.

To the photo-alignment film material may be added in advance a monomer with multiple functional groups such as epoxy, carboxylic acid, amine, acrylate, or methacrylate groups. Such a material can improve the long-term reliability. The monomer functions as a cross-linking agent for the polymer, and forms a mesh structure in the photo-alignment film. As a result, the monomer prevents impurities in the photo-alignment film and the substrates (e.g., color filter substrate), for example, from being mixed into the liquid crystal, and sufficiently prevents a decrease in the voltage holding ratio in long-term use of the liquid crystal display device.

The substrates may include a thin-film transistor array substrate provided with thin-film transistors, and the thin-film transistors may each contain a semiconductor layer containing an oxide semiconductor.

The oxide semiconductor has features of a higher degree of mobility and smaller characteristic variation than amorphous silicon. Therefore, thin-film transistors containing an oxide semiconductor can be driven at a high speed with a high drive frequency and each occupy a small portion of one pixel, compared with thin-film transistors containing amorphous silicon. Such thin-film transistors are therefore suited for driving next-generation display devices with a higher definition. Also, an oxide semiconductor film, which can be formed by a more simple process than a polycrystalline silicon film, has an advantage that it is applicable to a device requiring a large area. Accordingly, in the case that the substrates include a thin-film transistor array substrate with thin-film transistors each having a semiconductor layer containing an oxide semiconductor, a liquid crystal display device can be manufactured which can achieve the effects of the one aspect of the present invention and achieve high-speed driving.

The oxide semiconductor may be, for example, a compound (In—Ga—Zn—O) consisting of indium (In), gallium (Ga), zinc (Zn), and oxygen (O), a compound (In-Tin-Zn—O) consisting of indium (In), tin (Tin), zinc (Zn), and oxygen (O), or a compound (In—Al—Zn—O) consisting of indium (In), aluminum (Al), zinc (Zn), and oxygen (O).

In the case that the oxide semiconductor happens to contain moisture, the moisture may decrease the oxygen ratio in the semiconductor to change the characteristics of the semiconductor. For this reason, in order to prevent the oxide semiconductor from containing moisture even in case that moisture enters the liquid crystal display panel, the photo-alignment film material preferably has resistance to water. Suitable examples of the water-resistant polymer include polymers having a polyimide skeleton.

The above step (2) (hereinafter, also referred to as a pre-baking step) is, for example, a step of heating and drying the film to evaporate the solvent. Here, the pre-baking step may partially or substantially completely remove the solvent. The pre-baking step is performed using a heating device set to a given temperature, such as a hot plate or a baking furnace. The pre-baking step can give a uniform thickness to the resulting photo-alignment film, achieving favorable display quality.

The above step (3) (hereinafter, also referred to as a post-baking step) with gradual baking at multiple temperatures from a low temperature to a high temperature enables sufficient removal of the solvent to promote layer separation of the photo-reactive polymer and the other polymer(s). This step can therefore cause the photo-reactive polymers to be exposed sufficiently on the liquid crystal layer side of the alignment film, enabling highly efficient re-alignment of the side chains in the subsequent polarized-light irradiation step. The post-baking step can be performed using a heating device set to a given temperature, such as a hot plate or a baking furnace.

The expression “post-baking the pre-baked film gradually at multiple temperatures from a low temperature to a high temperature” means, for example, post-baking with an intentionally manipulated temperature profile such as gradual post-baking with multiple constant-temperature stages of different temperatures or post-baking with varied temperature-increase rates to heat the film substantially at multiple temperatures. The expression does not mean post-baking the substrate with the film formed thereon using a heating device such as a hot plate or a baking furnace set to a given temperature with a naturally generated temperature profile resulting from simple heating or a temperature profile resulting from heating at a single temperature, instead of the intentionally manipulated temperature profile as described above. Here, the constant-temperature stages may each refer to a period during which the heating is performed within a temperature range of ±5° C. for one or more minutes.

The post-baking step (3) may be performed using multiple heating devices set to different temperatures. In this case, the pre-baked film can be suitably post-baked gradually at multiple temperatures from a low temperature to a high temperature. Also, compared with the case of using a single heating device, the production efficiency can be further increased.

The above post-baking step (3) may be performed using a single heating device by gradually changing the temperature of the device. In this case, the pre-baked film can be suitably post-baked gradually at multiple temperatures from a low temperature to a high temperature. Also, compared with the case of using multiple heating devices, the heating device installation area can be reduced, and the degree of freedom in the device layout can be increased.

The post-baking step (3) may be performed by moving the substrate within a heating device including a temperature gradient region. In this case, the pre-baked film can be suitably post-baked gradually at multiple temperatures from a low temperature to a high temperature.

The above step (4) (hereinafter, also referred to as a polarized-light irradiation step) performs photo-alignment treatment on the post-baked film. Here, polarized UV light is suitable for use, preferably polarized light having a wavelength of 200 nm to 400 nm, more preferably a wavelength of 300 nm to 400 nm. The irradiation dose of the polarized light is, for example, preferably 200 mJ/cm² or smaller, more preferably 100 mJ/cm² or smaller, still more preferably 50 mJ/cm² or smaller.

In the present embodiment, the pre-baking step and the post-baking step enable sufficient layer separation of the two or more polymers in the alignment film. The method therefore enables production of a liquid crystal display device having a favorable contrast ratio even with a reduced irradiation dose of the polarized light. Also, since the method includes the polarized-light irradiation step after the post-baking step, the method can prevent self-organization of the alignment film, keep the anisotropy of the alignment film at a low level, and therefore produce a liquid crystal display device having a favorable viewing angle property.

The liquid crystal display device may be in an in-plane switching (IPS) mode or a fringe field switching (FFS) mode in each of which the pre-tilt angle is substantially 0°. The photo-alignment film constituting such a liquid crystal display device may be one that aligns the liquid crystal molecules in a direction parallel to the main surfaces of the substrates (hereinafter, such a photo-alignment film is also referred to as a horizontal photo-alignment film). The horizontal photo-alignment film may be any horizontal photo-alignment film that aligns at least the nearby liquid crystal molecules in substantially parallel with the surface of the film. The expression “the pre-tilt angle is substantially 0°” means that, for example, the pre-tilt angle of the liquid crystal molecules from the surfaces of the horizontal photo-alignment film is 1° or smaller.

The liquid crystal molecules may have positive anisotropy of dielectric constant or negative anisotropy of dielectric constant. The positive anisotropy of dielectric constant is Δε=1 to 20, for example, while the negative anisotropy of dielectric constant is Δε=−20 to −1, for example.

The present invention is described in more detail based on the following examples. The present invention, however, is not limited to these examples. The following examples may appropriately be combined or modified within the spirit of the present invention.

### EXAMPLE 1

A method for manufacturing a liquid crystal display device according to Example 1 is described step by step below.

### (Substrate for Photo-Alignment Film Formation)

A thin-film transistor (TFT) substrate having an electrode structure for the FFS mode and containing components such as In—Ga—Zn—O-based oxide semiconductors, and a color filter (CF) substrate provided with photo-spacers having a height of 3.2 μm were prepared.

### (Photo-Alignment Film Material)

The photo-alignment film material was prepared which contained a photo-reactive polymer, a non-photo-reactive polymer, and a solvent.

The photo-reactive polymer used contained polysiloxane in the main chain and a cinnamate group as a photo-functional group in a side chain. The non-photo-reactive polymer used was polyamic acid obtained by reacting cyclobutane-1,2,3,4-tetracarboxylic dianhydride (CBDA) and diamine having a biphenyl structure. The solvent used was a 50:50 (weight ratio) mixture of N-methyl-2-pyrrolidone and ethylene glycol monobutyl ether. The solids concentration in the photo-alignment film material was 4 wt %. The mixing ratio of the photo-reactive polymer and the non-photo-reactive polymer was 3:7. That is, the proportion of the photo-reactive polymer was 30 wt % and the proportion of the non-photo-reactive polymer was 70 wt % in the total solids content of the photo-alignment film material.

### (Step of Forming Film of Photo-Alignment Film Material)

On each of the TFT substrate and the CF substrate was formed a film of a photo-alignment film material by spin coating.

### (Pre-Baking Step)

Subsequently, the film of the photo-alignment film material was pre-baked at 70° C. for two minutes. The pre-baking was performed on a hot plate (trade name: EC-1200N) available from As One Corporation. The pre-baked film had a thickness of about 100 nm.

### (Post-Baking Step)

The pre-baked film was then subjected to a two-stage post-baking step. The first stage of the post-baking step was performed at 110° C. for 15 minutes, and the second stage was performed at 200° C. for 30 minutes. The post-baking was performed on a hot plate (trade name: EC-1200N) available from As One Corporation.

### (Polarized-Light Irradiation Step)

The post-baked film was irradiated with linearly polarized UV light from the normal direction. The irradiation dose of the linearly polarized UV light was 30 mJ/cm² at a center wavelength of about 313 nm. Here, the post-baked film on the TFT substrate was irradiated with linearly polarized light such that the polarized-light irradiation direction was substantially perpendicular to the slit direction of the electrode for the FFS mode.

After the polarized-light irradiation step, a thermosetting sealant was poured onto the TFT substrate with a dispenser. The TFT substrate and the CF substrate were attached to each other, and a liquid crystal material containing liquid crystal molecules having positive anisotropy of dielectric constant was sealed between the substrates. The liquid crystal material used had an anisotropy of dielectric constant of 7. The TFT substrate and the CF substrate were attached to each other, with the polarization directions of the polarized UV light irradiation being parallel to each other. The workpiece was then heated at 130° C. for 40 minutes for curing of the thermosetting sealant and re-alignment treatment of the liquid crystal molecules, whereby a liquid crystal display panel with uniformly, uniaxially aligned liquid crystal molecules was obtained.

Members such as polarizers and a backlight were properly disposed on the obtained liquid crystal display panel, so that a liquid crystal display device of Example 1 was completed.

### EXAMPLE 2

A method for manufacturing a liquid crystal display device according to Example 2 is the same as the method for manufacturing a liquid crystal display device according to Example 1, except that the structure of the photo-reactive polymer was changed. In Example 2, the photo-reactive polymer used was one containing polyamic acid in the main chain and a cinnamate group as a photo-functional group in a side chain. The mixing ratio of the photo-reactive polymer and the non-photo-reactive polymer was 3:7. That is, the proportion of the photo-reactive polymer was 30 wt % and the proportion of the non-photo-reactive polymer was 70 wt % in the total solids content of the photo-alignment film material.

### COMPARATIVE EXAMPLE 1

A method for manufacturing a liquid crystal display device according to Comparative Example 1 is the same as the method for manufacturing a liquid crystal display device according to Example 1, except that the structure of the photo-reactive polymer was changed. In Comparative Example 1, the photo-reactive polymer used was one containing polyamic acid and a cinnamate group as a photo-functional group in the main chain. The mixing ratio of the photo-reactive polymer and the non-photo-reactive polymer was 3:7. That is, the proportion of the photo-reactive polymer was 30 wt % and the proportion of the non-photo-reactive polymer was 70 wt % in the total solids content of the photo-alignment film material.

### [Evaluation: Examples 1 and 2 and Comparative Example 1]

The contrast ratio of each of the liquid crystal display devices manufactured by the methods for manufacturing a liquid crystal display device according to Examples 1 and 2 and Comparative Example 1 was evaluated.

### (Contrast Ratio)

The contrast ratio (CR) was defined as (contrast ratio)=(luminance in white display)/(luminance in black display). The white display is the state with voltage giving the maximum luminance applied, and the black display is the state with no voltage applied. The luminance was measured using a spectroradiometer (trade name: SR-UL2) available from Topcon Technohouse Corporation. A liquid crystal display device having a contrast ratio of 1000 or higher was considered acceptable as a product. A liquid crystal display device having a contrast ratio of 1000 or higher was evaluated as “good”, and a liquid crystal display device having a contrast ratio of lower than 1000 was evaluated as “poor”.

The evaluation results of the contrast ratio in each of Examples 1 and 2 and Comparative Example 1 are shown in the following Table 1.

TABLE 1

| | Photo-reactive polymer | | Evaluation | |
|---|---|---|---|---|
| | Main chain structure | Side chain structure | CR | |
| Example 1 | Polysiloxane | Cinnamate group | 1200 | Good |
| Example 2 | Polyamic acid | Cinnamate group | 1200 | Good |
| Comparative | Polyamic acid, | None | 100 or | Poor |
| Example 1 | cinnamate group | | lower | |

As shown in Table 1, the contrast ratio in each of Examples 1 and 2 was 1200, which means that a contrast ratio suitable for a product was achieved even with a small irradiation dose of the polarized light. The contrast ratio in Comparative Example 1 was 100 or lower, which means that the liquid crystal molecules were hardly aligned. In the case of using a photo-reactive polymer containing a photo-functional group in the main chain as in Comparative Example 1, it is difficult to unidirectionally align the liquid crystal molecules even through irradiation of linearly polarized UV light in the polarized-light irradiation step after the post-baking step. As a result, the photo-alignment film has significantly deteriorated sensitivity, failing to achieve a favorable constant ratio.

### COMPARATIVE EXAMPLE 2

A method for manufacturing a liquid crystal display device according to Comparative Example 2 is the same as the method for manufacturing a liquid crystal display device according to Example 1, except that the structure of the photo-reactive polymer was changed, the order of the post-baking step and the polarized-light irradiation step was changed, and the post-baking step included only one stage at a single temperature.

In Comparative Example 2, the photo-reactive polymer used was one containing a polymer of methacrylic acid ester in the main chain and a cinnamate group as a photo-functional group in a side chain. By the same procedure as that in Example 1, a film of the photo-alignment film material was formed on each of the TFT substrate and the CF substrate and the pre-baking step was performed.

### (Polarized-Light Irradiation Step)

The pre-baked film on each of the TFT substrate and the CF substrate was irradiated with linearly polarized UV light from the normal direction. The irradiation dose of the linearly polarized UV light was 5 mJ/cm² at a center wavelength of about 313 nm.

### (Post-Baking Step)

The film irradiated with the polarized light on each of the TFT substrate and the CF substrate was post-baked. The post-baking step was performed at 140° C. for 20 minutes.

### [Evaluation: Example 1 and Comparative Example 2]

The contrast ratio, viewing angle, and retardation of each of the liquid crystal display devices manufactured by the methods for manufacturing a liquid crystal display device according to Example 1 and Comparative Example 2 were evaluated. The contrast ratio was measured by the above method.

### (Viewing Angle Property)

The viewing angle was evaluated based on the level of an apparently white-tinged image determined by calculating the ratio of an oblique luminance to a front luminance of the liquid crystal display device. Using a viewing angle measurement device (trade name: EZ-contrast) available from ELDIM, the front luminance T_{front} and the oblique luminance T_{oblique} (polar angle: 60°, azimuth: 30°) of the panel at a gray scale value of 64 were measured, so that the T_{oblique}/T_{front} value was calculated. For example, a luminance ratio of 2 indicates that the luminance in the oblique direction is twice that in the front direction. A luminance ratio of 2 or greater was found to be problematic in a product. Hence, a T_{oblique}/T_{front} value of smaller than 2 was evaluated as “good”, and a T_{oblique}/T_{front} value of 2 or smaller was evaluated as “poor”.

### (Retardation)

The retardation (phase difference) of each of the TFT substrate and the CF substrate with a photo-alignment film formed thereon was measured, and the retardation and the axial azimuth of the photo-alignment film were evaluated. Using a polarized light and retardation analysis/evaluation system (AxoScan) available from Axometrics, the retardation was measured from the normal direction of the substrate at a wavelength of 550 nm. A retardation of 10 nm or smaller indicates favorable display quality. The slow axis direction of the retardation was an in-plane direction perpendicular to the polarization direction of the irradiated light for alignment, both in Example 1 and Comparative Example 2.

The evaluation results of the contrast ratio, viewing angle, and retardation in each of Example 1 and Comparative Example 2 are shown in the following Table 2.

TABLE 2

| | Photo-reactive polymer | | Evaluation | | | | |
|---|---|---|---|---|---|---|---|
| | Main chain structure | Side chain structure | CR | | Viewing angle | | Retarddation |
| Example 1 | Polysiloxane | Cinnamate group | 1200 | Good | 1.3 | Good | 0.1 nm |
| Comparative | Methacrylic acid ester | Cinnamate group | 1200 | Good | 2.1 | Poor | 20 nm |
| Example 2 | polymer | | | | | | |

As shown in Table 2, the contrast ratio in each of Example 1 and Comparative Example 2 was 1200, which was favorable. In contrast, the viewing angle property was favorable with a T_{oblique}/T_{front} value of 1.3 in Example 1, and the T_{oblique}/T_{front} value was 2.1 and a significant apparently white-tinged image was observed in Comparative Example 2. Also, the retardation in Example 1 was 0.1 nm, which was very small, whereas the retardation in Comparative Example 2 was 20 nm, which was very large. In Comparative Example 2, the post-baking step was performed after the polarized-light irradiation step, so that the polymer constituting the photo-alignment film was self-organized. As a result, the anisotropy of the alignment film was increased, the retardation got very large, and the viewing angle property got worse. The method for manufacturing a liquid crystal display device according to Example 1 kept the retardation in the photo-alignment film at a low level, and produced a liquid crystal display device having a favorable viewing angle property.

### EXAMPLE 3-1

A method for manufacturing a liquid crystal display device according to Example 3-1 is the same as the method for manufacturing a liquid crystal display device according to Example 1, except that the first stage of the post-baking step was performed at 90° C. for 15 minutes.

### EXAMPLE 3-2

A method for manufacturing a liquid crystal display device according to Example 3-2 is the same as the method for manufacturing a liquid crystal display device according to Example 1, except that the first stage of the post-baking step was performed at 130° C. for 15 minutes.

### EXAMPLE 3-3

A method for manufacturing a liquid crystal display device according to Example 3-3 is the same as the method for manufacturing a liquid crystal display device according to Example 1, except that the first stage of the post-baking step was performed at 150° C. for 15 minutes.

### EXAMPLE 3-4

A method for manufacturing a liquid crystal display device according to Example 3-4 is the same as the method for manufacturing a liquid crystal display device according to Example 1, except that the first stage of the post-baking step was performed at 170° C. for 15 minutes.

### COMPARATIVE EXAMPLE 3

A method for manufacturing a liquid crystal display device according to Comparative Example 3 is the same as the method for manufacturing a liquid crystal display device according to Example 1, except that only one stage of the post-baking step was performed at a single temperature. In Comparative Example 3, the pre-baked film on each of the TFT substrate and the CF substrate was post-baked at 200° C. for 30 minutes.

### [Evaluation: Example 1, Examples 3-1 to 3-4, and Comparative Example 3]

The contrast ratio of each of the liquid crystal display devices manufactured by the methods for manufacturing a liquid crystal display device according to Example 1, Examples 3-1 to 3-4, and Comparative Example 3 was evaluated. The contrast ratio was measured by the above method. The evaluation results are shown in the following Table 3.

TABLE 3

| | Post-baking conditions | | | | | |
|---|---|---|---|---|---|---|
| | First stage | | Second stage | | | |
| | Temperature | Time | Temperature | Time | Evaluation | |
| | (° C.) | (min) | (° C.) | (min) | CR | |
| Example 1 | 110 | 15 | 200 | 30 | 1200 | Good |
| Example 3-1 | 90 | 15 | 200 | 30 | 1100 | Good |
| Example 3-2 | 130 | 15 | 200 | 30 | 1200 | Good |
| Example 3-3 | 150 | 15 | 200 | 30 | 1200 | Good |
| Example 3-4 | 170 | 15 | 200 | 30 | 1100 | Good |

| | | | | | |
|---|---|---|---|---|---|
| Comparative | N/A | 200 | 30 | 800 | Poor |
| Example 3 | | | | | |

As shown in Table 3, the contrast ratio of the liquid crystal display device manufactured was insufficient in Comparative Example 3 in which the post-baking step consists of only one stage. The contrast ratio was insufficient presumably because the post-baking step consisting of only one stage caused insufficient layer separation of the photo-alignment film, resulting in mixing of the photo-reactive polymer and the non-photo-reactive polymer. Also, the results of Example 1 and Examples 3-1 to 3-4 confirmed that performing the first stage of the post-baking at a temperature in the range of 90° C. to 170° C. enables production of a liquid crystal display device having a favorable contrast ratio.

### EXAMPLE 4-1

A method for manufacturing a liquid crystal display device according to Example 4-1 is the same as the method for manufacturing a liquid crystal display device according to Example 1, except that the second stage of the post-baking step was performed at 220° C. for 30 minutes.

### EXAMPLE 4-2

A method for manufacturing a liquid crystal display device according to Example 4-2 is the same as the method for manufacturing a liquid crystal display device according to Example 1, except that the second stage of the post-baking step was performed at 240° C. for 30 minutes.

### [Evaluation: Example 1, Examples 4-1 and 4-2]

The contrast ratio and voltage holding ratio (VHR) of each of the liquid crystal display devices manufactured by the methods for manufacturing a liquid crystal display device according to Example 1 and Examples 4-1 and 4-2 were evaluated. The contrast ratio was measured by the above method.

### (Voltage Holding Ratio)

The voltage holding ratio was measured using a liquid crystal physical property evaluation system (trade name: Model 6254) available from Toyo Corporation, with an applied voltage of 5 V, a holding time of 16.67 ms, and a measurement temperature of 60° C.

The evaluation results of the contrast ratio and voltage holding ratio in each of Example 1 and Examples 4-1 and 4-2 are shown in the following Table 4.

TABLE 4

| | Post-baking conditions | | | | | | |
|---|---|---|---|---|---|---|---|
| | First stage | | Second stage | | | | |
| | Temperature | Time | Temperature | Time | Evaluation | | |
| | (° C.) | (min) | (° C.) | (min) | CR | | VHR (%) |
| Example 1 | 110 | 15 | 200 | 30 | 1200 | Good | 99.0 |
| Example 4-1 | 110 | 15 | 220 | 30 | 1200 | Good | 99.2 |
| Example 4-2 | 110 | 15 | 240 | 30 | 1200 | Good | 99.2 |

As shown in Table 4, performing the second stage of the post-baking at a temperature in the range of 200° C. to 240° C. led to a favorable contrast ratio and a high VHR of 99% or higher in each of Example 1 and Examples 4-1 and 4-2. The manufactured liquid crystal display device had a high VHR presumably because performing the second stage of the post-baking at 200° C. or higher allowed imidization of the polyamic acid constituting the photo-alignment film to proceed sufficiently.

### EXAMPLE 5-1

A method for manufacturing a liquid crystal display device according to Example 5-1 is the same as the method for manufacturing a liquid crystal display device according to Example 1, except that the pre-baking step was performed at 80° C. for two minutes.

### EXAMPLE 5-2

A method for manufacturing a liquid crystal display device according to Example 5-2 is the same as the method for manufacturing a liquid crystal display device according to Example 1, except that the pre-baking step was performed at 60° C. for two minutes.

### EXAMPLE 5-3

A method for manufacturing a liquid crystal display device according to Example 5-3 is the same as the method for manufacturing a liquid crystal display device according to Example 1, except that the pre-baking step was performed at 50° C. for two minutes.

### [Evaluation: Example 1 and Examples 5-1 to 5-3]

The contrast ratio of each of the liquid crystal display devices manufactured by the methods for manufacturing a liquid crystal display device according to Example 1 and Examples 5-1 to 5-3 was evaluated. The contrast ratio was measured by the above method. The evaluation results are shown in the following Table 5.

TABLE 5

| | | | Post-baking conditions | | | | | |
|---|---|---|---|---|---|---|---|---|
| | Pre-baking conditions | | First stage | | Second stage | | | |
| | Temperature | Time | Temperature | Time | Temperature | Time | Evaluation | |
| | (° C.) | (min) | (° C.) | (min) | (° C.) | (min) | CR | |
| Example 1 | 70 | 2 | 110 | 15 | 200 | 30 | 1200 | Good |
| Example 5-1 | 80 | 2 | 110 | 15 | 200 | 30 | 1200 | Good |
| Example 5-2 | 60 | 2 | 110 | 15 | 200 | 30 | 1200 | Good |
| Example 5-3 | 50 | 2 | 110 | 15 | 200 | 30 | 1200 | Good |

As shown in Table 5, performing the first stage of the pre-baking at a temperature in the range of 50° C. to 80° C. was confirmed to produce a liquid crystal display device having a favorable contrast ratio.

### EXAMPLE 6

A method for manufacturing a liquid crystal display device according to Example 6 is the same as the method for manufacturing a liquid crystal display device according to Example 1, except that a step of forming an alignment-sustaining layer on the photo-alignment film was performed after the step of irradiating the post-baked film with polarized light.

### (Formation of Alignment-Sustaining Layer)

The polarized-light irradiation step was performed by the same procedure as that in Example 1. The TFT substrate and the CF substrate were attached to each other, and a liquid crystal material containing biphenyl-4,4′-diyl bis(2-methylacrylate) as a polymerizable monomer was sealed between the substrates. The amount of biphenyl-4,4′-diyl bis(2-methylacrylate) was 0.5 wt % of the whole amount of the liquid crystal material. Thereafter, a liquid crystal display panel was obtained by the same procedure as that in Example 1.

The obtained liquid crystal display panel was irradiated with UV light with an irradiation dose of 2 J/cm² using a black light having a center wavelength of about 350 nm with no voltage applied, so that the polymerizable monomer in the liquid crystal layer was polymerized.

### [Evaluation: Example 6]

The image sticking property in the liquid crystal display device manufactured by the method for manufacturing a liquid crystal display device according to Example 6 was evaluated.

### (Image Sticking Property)

The image sticking property was evaluated based on the image sticking ratio. First, regions X and Y to which different voltages are applicable were formed in one liquid crystal panel, and a voltage giving the maximum luminance was applied to the region X for 24 hours. The region Y was left for 24 hours with no voltage applied. Then, a voltage giving a luminance of 1% of the maximum luminance was applied to both of the regions X and Y. The luminance was measured. The luminance in the region X was defined as T(x), and the luminance in the region Y was defined as T(y). The image sticking ratio was calculated from the formula ΔT=(|T(x)−T(y)|/T(y))×100. The luminance was measured using a digital camera (trade name: EOS Kiss Digital NEF-S18-55IIU) available from Canon Inc.

The image sticking ratio in Example 6 was 4%, which was very favorable. Also, no image sticking was visually observed through an ND filter (10%).

### EXAMPLE 7

A method for manufacturing a liquid crystal display device according to Example 7 is the same as the method for manufacturing a liquid crystal display device according to Example 1, except that the liquid crystal display device includes a liquid crystal layer containing liquid crystal molecules with negative anisotropy of dielectric constant, and the irradiation direction in the polarized-light irradiation step was different. The liquid crystal material used had an anisotropy of dielectric constant of −4.

### (Polarized-Light Irradiation Step)

The post-baked film on each of the TFT substrate and the CF substrate was irradiated with linearly polarized UV light from the normal direction. The irradiation dose of the linearly polarized UV light was 30 mJ/cm² at a center wavelength of about 313 nm. In Example 7, the film on the TFT substrate was irradiated with the linearly polarized UV light such that the polarized-light irradiation direction and the slit direction of the FFS-mode electrodes were substantially parallel to each other.

### [Evaluation: Example 7]

The contrast ratio of the liquid crystal display device manufactured by the method for manufacturing a liquid crystal display device according to Example 7 was evaluated. The contrast ratio was measured by the above method. The contrast ratio in Example 7 was 1600, which was even higher than the contrast ratio in Example 1.

### EXAMPLE 8-1

A method for manufacturing a liquid crystal display device according to Example 8-1 is the same as the method for manufacturing a liquid crystal display device according to Example 1, except that the mixing ratio of the photo-reactive polymer and the non-photo-reactive polymer was different. In Example 8-1, the mixing ratio of the photo-reactive polymer and the non-photo-reactive polymer was 10:90. That is, the proportion of the photo-reactive polymer was 10 wt % and the proportion of the non-photo-reactive polymer was 90 wt % in the total solids content of the photo-alignment film material.

### EXAMPLE 8-2

A method for manufacturing a liquid crystal display device according to Example 8-2 is the same as the method for manufacturing a liquid crystal display device according to Example 1, except that the mixing ratio of the photo-reactive polymer and the non-photo-reactive polymer was different. In Example 8-2, the mixing ratio of the photo-reactive polymer and the non-photo-reactive polymer was 5:95. That is, the proportion of the photo-reactive polymer was 5 wt % and the proportion of the non-photo-reactive polymer was 95 wt % in the total solids content of the photo-alignment film material.

### EXAMPLE 8-3

A method for manufacturing a liquid crystal display device according to Example 8-3 is the same as the method for manufacturing a liquid crystal display device according to Example 1, except that the mixing ratio of the photo-reactive polymer and the non-photo-reactive polymer was different. In Example 8-3, the mixing ratio of the photo-reactive polymer and the non-photo-reactive polymer was 50:50. That is, the proportion of the photo-reactive polymer was 50 wt % and the proportion of the non-photo-reactive polymer was 50 wt % in the total solids content of the photo-alignment film material.

### EXAMPLE 8-4

A method for manufacturing a liquid crystal display device according to Example 8-4 is the same as the method for manufacturing a liquid crystal display device according to Example 1, except that the mixing ratio of the photo-reactive polymer and the non-photo-reactive polymer was different. In Example 8-4, the mixing ratio of the photo-reactive polymer and the non-photo-reactive polymer was 2.5:97.5. That is, the proportion of the photo-reactive polymer was 2.5 wt % and the proportion of the non-photo-reactive polymer was 97.5 wt % in the total solids content of the photo-alignment film material.

### [Evaluation: Example 1, Examples 8-1 to 8-4]

The contrast ratio and voltage holding ratio (VHR) of each of the liquid crystal display devices manufactured by the methods for manufacturing a liquid crystal display device according to Example 1 and Examples 8-1 to 8-4 were evaluated. The contrast ratio and VHR were measured by the above methods. The evaluation results are shown in the following Table 6.

TABLE 6

| | Proportions of photo- | | | | |
|---|---|---|---|---|---|
| | reactive polymer and | | | | |
| | non-photo-reactive polymer | | | | |
| | Photo-reactive | Non-photo-reactive | Evaluation | | |
| | polymer | polymer | | | VHR |
| | (wt %) | (wt %) | CR | | (%) |
| Example 1 | 30 | 70 | 1200 | Good | 99.0 |
| Example 8-1 | 10 | 90 | 1200 | Good | 99.3 |
| Example 8-2 | 5 | 95 | 1200 | Good | 99.3 |
| Example 8-3 | 50 | 50 | 1200 | Good | 98.8 |
| Example 8-4 | 2.5 | 97.5 | 1000 | Good | 99.3 |

As shown in Table 6, a favorable contrast ratio was achieved even in the case that the mixing ratio of the photo-reactive polymer and the non-photo-reactive polymer was changed from Example 1 to Examples 8-1 to 8-4. Also, in Examples 8-1, 8-2, and 8-4 in which the proportion of the non-photo-reactive polymer was higher than that in Example 1, the VHR was higher than that in Example 1. In contrast, in Example 8-3 in which the proportion of the non-photo-reactive polymer was lower than that in Example 1, the VHR was slightly lower than that in Example 1. The VHR changed presumably because of the following factors. That is, performing the post-baking step at two stages can promote layer separation of the photo-reactive polymer and the non-photo-reactive polymer. As a result, the photo-reactive polymer can be exposed sufficiently on the surface of the alignment film (on the liquid crystal layer side of the alignment film) even with a small mixing amount of the photo-reactive polymer. Here, a liquid crystal display device with higher reliability was manufactured presumably because decreasing the mixing amount of the photo-reactive polymer allowed an increase in the mixing amount of the non-photo-reactive polymer that has an effect on improvement of the electric characteristics.

Although the method in each of the above examples was a method for manufacturing an FFS-mode liquid crystal display device, it is clear that the effects of the one aspect of the present invention can be achieved even in a method for manufacturing an IPS-mode liquid crystal display device.

### [Additional Remarks]

The technical features described in the examples of the present invention can be combined with each other so that a new embodiment of the present invention can be made.

One aspect of the present invention may be a method for manufacturing a liquid crystal display device including a photo-alignment film, the method including, in the following order, the steps of: (1) forming on a substrate a film of a photo-alignment film material containing two or more polymers and a solvent; (2) pre-baking the film to evaporate the solvent; (3) post-baking the pre-baked film gradually at multiple temperatures from a low temperature to a high temperature; and (4) irradiating the post-baked film with polarized light, at least one of the two or more polymers being a photo-reactive polymer containing a photo-functional group in a side chain. The post-baking step performed gradually at multiple temperatures from a low temperature to a high temperature in the above aspect promotes layer separation of the photo-reactive polymer and the other polymer(s) in the alignment film to allow the photo-reactive polymer to be exposed on the surface of the alignment film. Accordingly, in the polarized-light irradiation step after the post-baking step, a liquid crystal display device having a favorable contrast ratio can be achieved even with a small irradiation dose of the polarized light. Also, the polarized-light irradiation step after the post-baking step avoids self-organization of the polymer, leading to a small retardation of the alignment film.

In the above aspect, for efficient volatilization of the solvent, the pre-baking step (2) may be performed at a temperature in the range of 50° C. to 80° C. If the pre-baking temperature is lower than 50° C., it may take time for volatilization of the above solvent, resulting in significant thickness unevenness due to convection of the solution. As a result, alignment unevenness may be perceived in lighting of the liquid crystal display device. If the pre-baking temperature is higher than 80° C., the solvent may rapidly volatilize, leading to a failure in favorable separation of the photo-reactive polymer and the other polymer(s) in the alignment film. For this reason, a subsequent multi-stage post-baking step may result in insufficient layer separation of the photo-reactive polymer and the other polymer(s) in the alignment film. Here, the expression “the pre-baking step (2) may be performed at a temperature in the range of 50° C. to 80° C.” means that, for example, the pre-baking is performed for a constant temperature period during which the temperature is in the range of 50° C. to 80° C. The constant temperature period during which the temperature is in the range of 50° C. to 80° C. may be, for example, a period during which heating is continued in the temperature range of ±5° C. for 30 seconds or longer. The baking time in the pre-baking step (2) is preferably from a lower limit of one minute to an upper limit of 10 minutes, more preferably from a lower limit of two minutes to an upper limit of five minutes.

In the above aspect, the post-baking step (3) may include a first stage of performing baking at a temperature in the range of 90° C. to 170° C. Here, the temperature is more preferably in the range of 110° C. to 150° C. It is important in the first stage of the post-baking to perform sufficient heating at a temperature lower than the temperature at which imidization of the polyamic acid proceeds, for volatilization of the solvent. In the case that the alignment film material contains polyamic acid, it is especially effective to promote layer separation in multi-stage post-baking because a highly polar solvent such as N-methyl-2-pyrrolidone (NMP) is less likely to volatilize. The baking time in the first stage of the post-baking step (3) is preferably from a lower limit of five minutes to an upper limit of 60 minutes, more preferably from a lower limit of 10 minutes to an upper limit of 30 minutes.

In the above aspect, the post-baking step (3) may include a final stage that is performed at a temperature in the range of 200° C. to 240° C. The final stage of the post-baking at a temperature as high as 200° C. or higher allows the imidization of polyamic acid to proceed sufficiently to give a higher VHR. The lower limit of the temperature in the final stage of the post-baking is 220° C. The baking time in the final stage of the post-baking step (3) is preferably from a lower limit of 15 minutes to an upper limit of 90 minutes, more preferably from a lower limit of 20 minutes to an upper limit of 60 minutes.

In the above aspect, the photo-functional group may be a cinnamate group.

In the above aspect, the photo-reactive polymer may have at least one structure selected from the group consisting of polysiloxane, polyamic acid, polyimide, and maleimide.

In the above aspect, the two or more polymers may include a non-photo-reactive polymer with at least one of polyamic acid and polyimide as a main chain.

The polyamic acid in the photo-reactive polymer and the non-photo-reactive polymer may partially be subjected to thermal chemical reaction (thermal imidization), which enables control of the electric characteristics of the photo-alignment film, such as the resistivity and dielectric constant. Also, the photo-reactive polymer and the non-photo-reactive polymer may each be a copolymer, for balanced control of the photo-reactive sensitivity, electric characteristics, and alignment characteristics.

In the above aspect, the proportion of the photo-reactive polymer in the total solids content of the photo-alignment film material may be 5 to 30 wt %. Even in the case that the proportion of the photo-reactive polymer is in the above range, the above steps (1) to (4) enable the photo-reactive polymer to be exposed sufficiently on the liquid crystal layer side of the alignment film. Also, since reduction of the amount of the photo-reactive polymer enables an increase in the proportion of the non-photo-reactive polymer that has an effect on improvement of the electric characteristics, the VHR can be further increased.

In the above aspect, the proportion of the non-photo-reactive polymer in the total solids content of the photo-alignment film material may be 70 to 95 wt %. Since the non-photo-reactive polymer has an effect on improvement of the electric characteristics, setting the proportion of the non-photo-reactive polymer in the above range leads to an even higher VHR.

In the above aspect, the method may further include a step of forming an alignment-sustaining layer on the film after the above step (4). Formation of an alignment-sustaining layer on the above film results in excellent image sticking property.

In the above aspect, the liquid crystal display device may include a liquid crystal layer that contains liquid crystal molecules having negative anisotropy of dielectric constant. Such a liquid crystal layer that contains liquid crystal molecules having negative anisotropy of dielectric constant can give an even higher contrast ratio to the resulting liquid crystal display device.

1. A method for manufacturing a liquid crystal display device including a photo-alignment film, the method comprising, in the following order, the steps of:
(1) forming on a substrate a film of a photo-alignment film material containing two or more polymers and a solvent;
(2) pre-baking the film to evaporate the solvent;
(3) post-baking the pre-baked film gradually at multiple temperatures from a low temperature to a high temperature; and
(4) irradiating the post-baked film with polarized light,
at least one of the two or more polymers being a photo-reactive polymer containing a photo-functional group in a side chain.

2. The method for manufacturing a liquid crystal display device according to claim 1,
wherein the pre-baking in the above step (2) is performed at a temperature in the range of 50° C. to 80° C.

3. The method for manufacturing a liquid crystal display device according to claim 1,
wherein the post-baking in the above step (3) includes a first stage that is performed at a temperature in the range of 90° C. to 170° C.

4. The method for manufacturing a liquid crystal display device according to claim 1,
wherein the post-baking in the above step (3) includes a final stage that is performed at a temperature in the range of 200° C. to 240° C.

5. The method for manufacturing a liquid crystal display device according to claim 1,
wherein the photo-functional group is a cinnamate group.

6. The method for manufacturing a liquid crystal display device according to claim 1,
wherein the photo-reactive polymer has at least one structure selected from the group consisting of polysiloxane, polyamic acid, polyimide, and maleimide.

7. The method for manufacturing a liquid crystal display device according to claim 1,
wherein the two or more polymers include a non-photo-reactive polymer with at least one of polyamic acid and polyimide as a main chain.

8. The method for manufacturing a liquid crystal display device according to claim 1,
wherein the proportion of the photo-reactive polymer in the total solids content of the photo-alignment film material is 5 to 30 wt %.

9. The method for manufacturing a liquid crystal display device according to claim 7,
wherein the proportion of the non-photo-reactive polymer in the total solids content of the photo-alignment film material is 70 to 95 wt %.

10. The method for manufacturing a liquid crystal display device according to claim 1, further comprising
a step of forming an alignment-sustaining layer on the film after the above step (4).

11. The method for manufacturing a liquid crystal display device according to claim 1,
wherein the liquid crystal display device includes a liquid crystal layer that contains liquid crystal molecules having negative anisotropy of dielectric constant.
